(19) United States
(12) Patent Application Publication
(10) Pub. No.: US 2005/0067464 A1
(43) Pub. Date: Mar. 31, 2005

(54) Fixture for supporting a printed circuit board in a production line

(76) Inventors: Peng-Wei Wang, Kaohsiung City (TW); Chun-Hsiung Chiu, Taoyuan Hsien (TW)

Correspondence Address: BIRCH STEWART KOLASCH & BIRCH, PO BOX 747, FALLS CHURCH, VA, 22040-0747, US

(21) Appl. No.: 10/928,142

(22) Filed: Aug. 30, 2004

(30) Foreign Application Priority Data
Sep. 30, 2003 (TW) 092127078

(51) Int. Cl. B23K 37/04

(52) U.S. Cl. 228/49.5

(57) ABSTRACT

A fixture for supporting a printed-circuit board (PCB) has an outer frame, an inner frame and at least two inner connection members. A production line has at least two conveyor belts. The outer frame has two outer side supports for laying on the conveyor and being movable therewith, the inner frame is used for holding the PCB, and the inner connection members couple the inner frame with the outer frame for adjusting the installation angle of inner frame with the outer frame.

### FIELD OF THE INVENTION

The present invention relates to a fixture for supporting a printed-circuit board (PCB) in a production line and particularly to a frame fixture that supports a printed-circuit board in adjustable angle.

### BACKGROUND OF THE INVENTION

PCB is a substrate for installing and connecting various different electronic elements to accomplish a selected effect through interconnection of the different electronic elements. The most commonly used PCBs are main board, VGA card, wireless network card and the like. The commonly used electronic elements on the PCBs include chip-set, capacitor, inductor, resistor and the like. Some of those electronic elements are mounted onto the PCB by surface mount technology (SMT), such as SMT elements; while some others are mounted onto the PCB by wave soldering, such as pin elements.

Wave soldering is a process in PCB's production line. It mainly employs a pump to generate an elongated tin wave on the surface of molten liquid-state tin in a tin oven, and the PCBs are carried by two parallel conveyor belts to pass through the tin oven to allow the liquid-state tin to form soldering points on the PCBs. The carrier supporting the PCBs in a production line for wave soldering is generally called frame fixture.

Refer to FIG. 1 for a conventional frame fixture 10. It is a hollow and rectangular structure consisting of four sides 12 and an opening 14 in the center. Each side 12 has a flange 16 extended from an inner edge. The edge of a PCB 18 may be rested on the flange 16 of each side 12. The upper surface of each side 12 has a plurality of clamp mechanisms 20 to apply a downward pressure on the upper surface of the PCB 18 so that the PCB 18 may be held and fixed firmly on the frame fixture 10. In addition, the frame fixture 10 has respectively a barrier plate 22 located on the front and the rear sides 12a and 12b to prevent the rising tin wave in the tin oven from flowing onto the upper surface of the PCB 18 and causing damage of the elements mounted thereon.

Referring to FIG. 2, the frame fixture 10 is a rectangular structure. When it is coupled with the PCB 18, it usually may be moved only in the X or Y direction to pass through the tin oven. When each component 24 passes through the tin oven, the through pins 26 located thereon have to go through a tin-dipping and tin-striping process to form solder points on the pins. However, in practice it often happens that the rear side (opposite to the moving direction) of the through pins 26 has some soldering tail 50 after the through pins 26 of the component 24 have passed through the tin oven. With the number of the through pins 26 increased more densely, the soldering tail 50 could connect to the neighboring through pins 26 and result in short circuit. At this time in time in time, the distance between the through pins 26 and the neighboring soldering tail 50 is d1.

As the through pins of many present components are configured more densely than before, product defective rate also increases. Hence by designing a rotatable frame fixture to enable the PCB to pass through the tin oven in different directions, and determine an optimal direction for passing through the tin oven according to different PCBs such as turning to the direction in which two abutting pin elements have the greatest interval, short circuit of neighboring through pins caused by the soldering tail may be reduced to minimum, and the production yield and the quality of the PCB may be greatly improved.

### SUMMARY OF THE INVENTION

Therefore the object of the invention is to provide a rotatable frame fixture to carry a PCB to pass through a tin oven in different directions to process wave soldering and determine a direction to pass through the tin oven to generate optimal production yield for the PCB.

The rotatable frame fixture according to invention aims at holding a PCB to pass through a tin oven to process wave soldering. It includes an outer frame, an inner frame and at least two inner connection members.

The outer frame includes at least two outer side supports laying on two parallel conveyor belts which carry the frame fixture passing through the tin oven. The inner frame is a hollow and rectangular structure which has flanges located on inner edges to hold the PCB. The inner frame further has clamp mechanisms located on the upper surface to fix the PCB. The inner frame and the outer frame are connected through the two inner connection members which are pivotally mounted on two diagonal comers of the inner frame. Thus the angle between the inner frame and the outer frame is adjustable to alter the angle of the PCB passing through the tin oven. In addition, the inner connection member has one end with a inner fastener located thereon. The outer frame has at least one outer fixing hole to connect with the inner fastener. The inner fastener may be a screw, wing nut or fixing pin.

The intervals of the two side supports and the two conveyor belts are adjustable to match the angular adjustment between the inner frame and the outer frame. The distance between the two diagonal comers of the inner frame after the angle of the inner frame has been adjusted also changes. More, the side supports may be made in reversed U-shape or L-shape, and are connected to two outer frame connection members through outer frame fasteners to form the rectangular and hollow structure. The outer frame fasteners may be screws, wing nuts or fixing pins.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional frame fixture.

FIG. 2 is a schematic view of through pins and neighboring soldering tail during applying a conventional frame fixture.

FIGS. 3A and 3B are schematic views of the rotatable frame fixture according to the invention.

FIGS. 4A and 4B are schematic views of different embodiments of the rotatable frame fixture according to the invention.

FIGS. 5A and 5B are schematic views of the rotatable frame fixture in different angle.

FIG. 6 is a schematic view of through pins and neighboring soldering tail during applying a ratatable frame fixture.

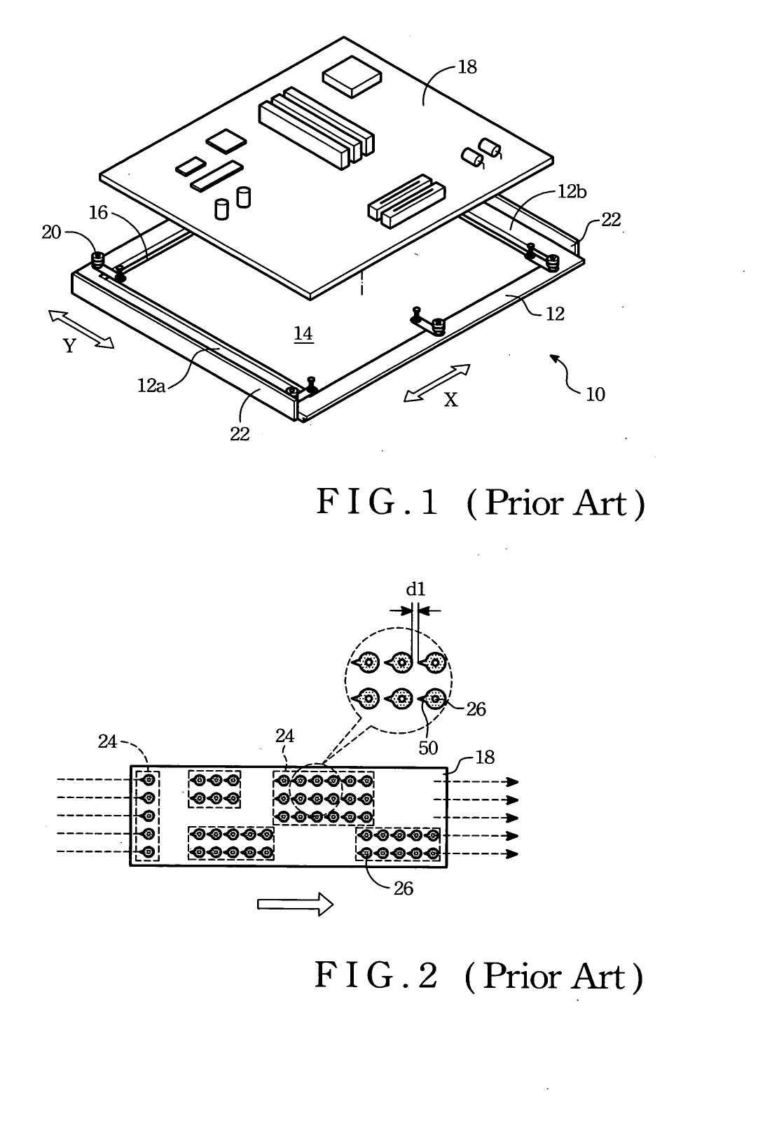

### DESCRIPTION OF THE PREFERRED EMBODIMENT

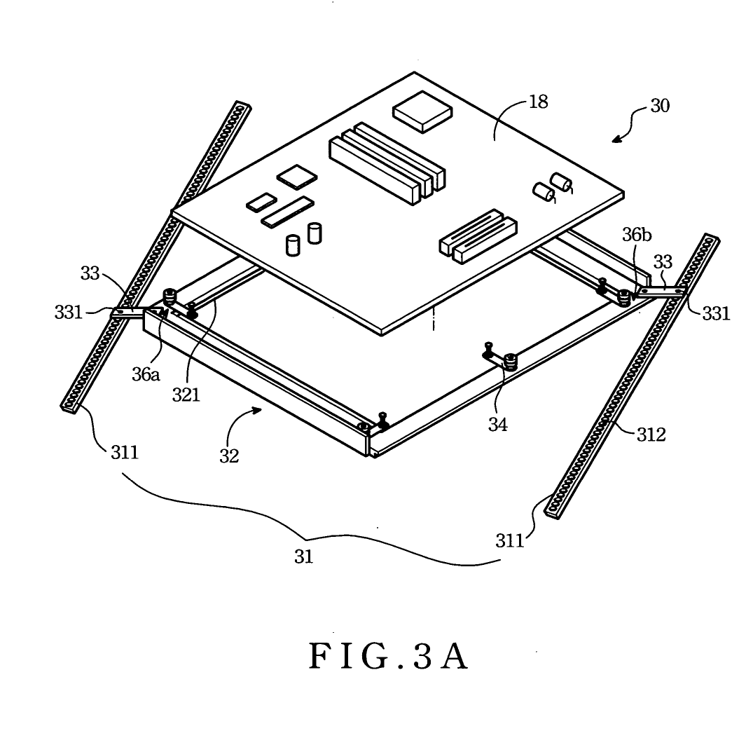

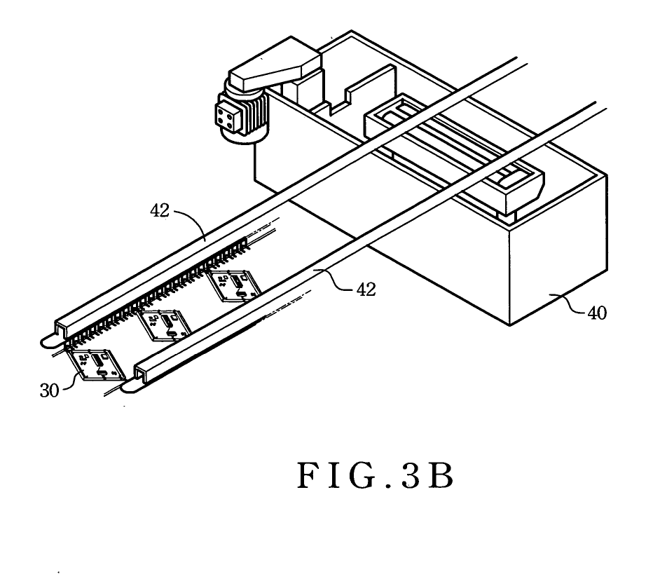

Refer to FIGS. 3A and 3B for a rotatable frame fixture 30. It includes an outer frame 31, an inner frame 32 and at least two inner connection members 33.

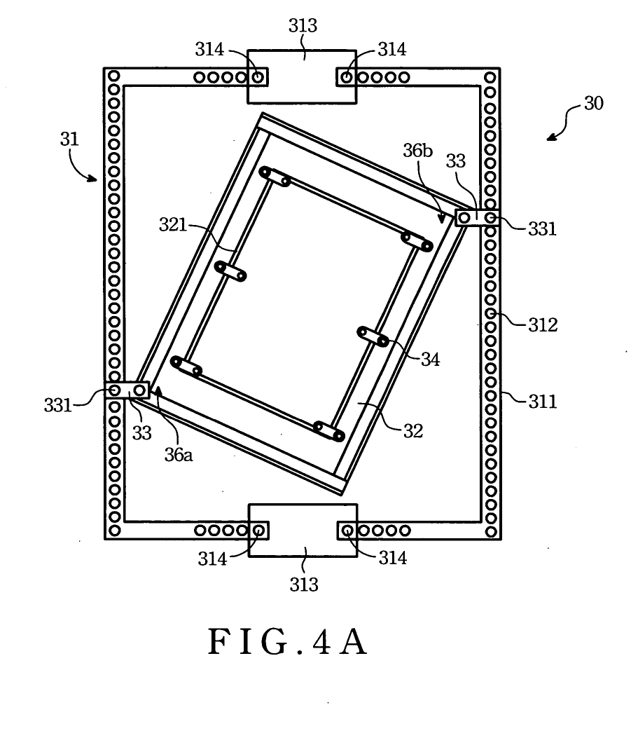

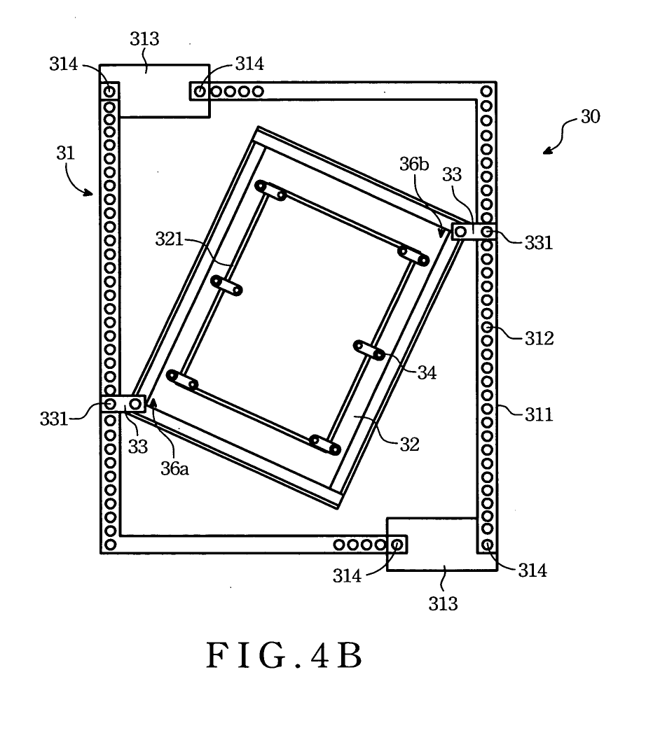

The outer frame 31 includes at least two outer side supports 311 laying on two parallel conveyor belts 42 which carry the frame fixture 30 passing a tin oven 40. The outer side supports 311 may be formed in reversed U-shape or L-shape (also referring to FIGS. 4A and 4B) to be coupled to form a hollow and rectangular structure. The two outer side supports 311 are connected by two outer frame connection members 313, and are fixed by outer frame fasteners 314. The outer frame fasteners 314 may be screws, wing nuts or fixing pins. The inner connection member 33 has one end with a inner fastener 331 located thereon. The outer frame 31 has a plurality of outer fixing holes 312. The inner connection member 33 is fastened to one of the outer fixing holes 312 by the inner fastener 331. The inner fastener 331 may be a screw, wing nut or fixing pin.

The inner frame 32 is a hollow and rectangular structure which has flanges 321 located on inner edges to hold a PCB 18. The inner frame 32 further has a plurality of clamp mechanisms 34 located on the upper surface to fix the PCB 18. The inner frame 32 and the outer frame 31 are connected through the two inner connection members 33. The inner connection members 33 are pivotally connected with the inner frame 32 at two diagonal comers 36a and 36b. The inner connection members 33 have other end opposite to the pivotal end and fasten to one of the outer fixing holes 312 of the outer frame through inner fastener 331. Because of the two diagonal comers 36a and 36b of the inner frame 32 are pivotally connected with the two inner connection members 33, the angle between the inner frame 32 and the outer frame 31 is adjustable. Thus the direction of the PCB 18 passing the tin oven 40 may be altered.

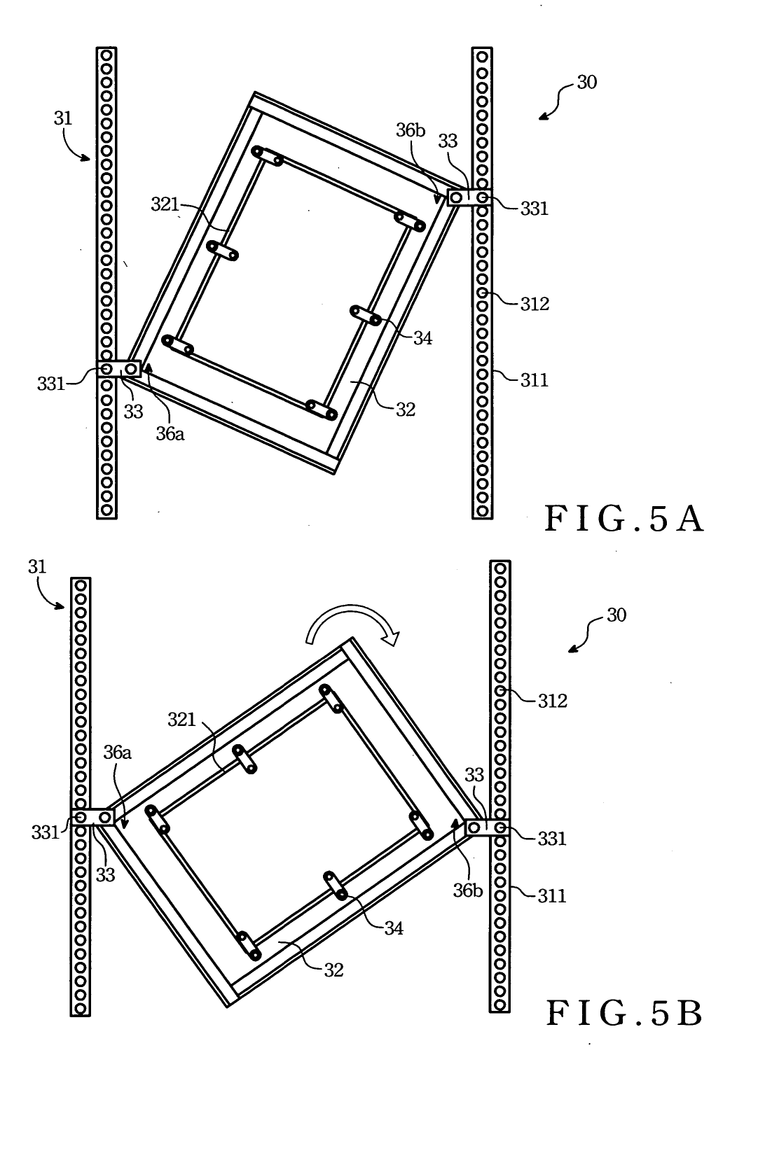

Referring to FIGS. 5A and 5B, when the angle of the inner frame 32 is turned, the distance between the two diagonal comers 36a and 36b also changes. The interval of the two outer side supports 311 and the interval of the two conveyor belts 42 also may be adjusted to match the turning of the inner frame 32 and to couple with the two diagonal comers 36a and 36b.

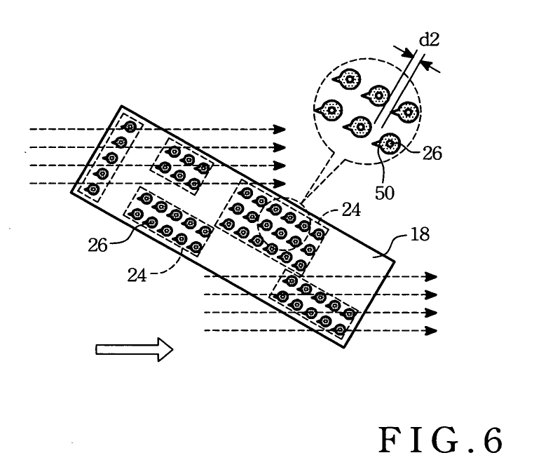

Referring to FIG. 6, a back side view of a component 24 with a plurality of through pins 26 located on the PCB 18. After the PCB 18 has been turned to a desired direction for passing the tin oven, the distance d2 between the through pins 26 and the neighboring soldering tail 50 is larger than d1. Thus it is less likely to incur short circuit caused by the soldering tail 50. Compared FIG. 6 with FIG. 2, short circuit phenomenon is significantly reduced for the component 24 in the wave soldering process. Of course, the surface of the PCB 18 may have various types of component 24. When the PCB 18 passes the tin oven 40 in different directions, the resulting soldering effects of the component 24 also are different. Hence tests should be performed to figure out the optimal direction and angle for the PCB 18 to pass through the tin oven 40.

As previously discussed, during the wave soldering process, the frame fixture according to the invention may be turned to change the direction of passing the tin oven. For a newly designed PCB in the test stage, the frame fixture of the invention may be used to process wave soldering test and reach an optimal direction and angle for the PCB to pass through the tin oven. Thereby production yield of the PCB in the wave soldering process may increase and quality may improve.

While the preferred embodiment of the invention has been set forth for the purpose of disclosure, modifications of the disclosed embodiment of the invention as well as other embodiments thereof may occur to those skilled in the art. Accordingly, the appended claims are intended to c all embodiments which do not depart from the spirit and scope of the invention.

1. A fixture for supporting a printed-circuit board (PCB) in a production line which has at least two parallel conveyor belts, comprising:
an outer frame which has two outer side supports laying on the conveyor belts and being movable therewith, the distance between the outer side supports is adjustable;
an inner frame for holding the PCB; and
at least two inner connection members for coupling the inner frame with the outer frame, the installation angle of inner frame with the outer frame is adjustable.

2. The fixture of claim 1, wherein the outer frame further comprises two parallel straight bars.

3. The fixture of claim 1, wherein each of the outer side supports is formed in reversed U-shape.

4. The fixture of claim 1, wherein each of the outer side supports is formed in L-shape.

5. The fixture of claim 1 further comprises at least two outer frame fasteners to fasten the outer side supports together, and the outer frame being substantially a rectangle frame.

6. The fixture of claim 5, wherein the outer frame fastener is a screw.

7. The fixture of claim 5, wherein the outer frame fastener is a wing nut.

8. The fixture of claim 5, wherein the outer frame fastener is a fixing pin.

9. The fixture of claim 5 further comprises two outer frame connection members, wherein the outer frame fasteners through the outer frame connection members and the outer side supports to connect the two outer side supports together.

10. The fixture of claim 1 further comprises at least two inner fasteners, wherein the inner fasteners through the inner connection members in order to couple the inner frame to the outer frame.

11. The fixture of claim 10 further comprising a plurality of outer fixing holes located in the outer side support, wherein the inner fastener through the inner connecting member and fix to one of the outer fixing hole.

12. The fixture of claim 10, wherein the inner fastener is a screw.

13. The fixture of claim 10, wherein the inner fastener is a wing nut.

14. The fixture of claim 10, wherein the inner fastener is a fixing pin.

15. The fixture of claim 1, wherein the inner connection members are pivotally connected with the inner frame.

16. The fixture of claim 1, wherein the inner connection members are pivotally connected with the comers of the inner frame.

17. The fixture of claim 1, wherein the distance between the two conveyor belts is adjustable.

18. The fixture of claim 1, wherein the inner frame is substantially a rectangle frame.

19. The fixture of claim 1, wherein the inner frame comprises at least one clamp mechanism pressing on the PCB, and fixes the PCB on the inner frame.

20. The fixture of claim 1, wherein the inner frame further comprises a flange to support the PCB.
